(19) United States
(12) Patent Application Publication
(10) Pub. No.: US 2003/0212853 A1
(43) Pub. Date: Nov. 13, 2003

(54) Adaptive processor architecture incorporating a field programmable gate array control element having at least one embedded microprocessor core

(76) Inventors: Jon M. Huppenthal, Colorado Springs, CO (US); Denis O. Kellam, Monument, CO (US)

Correspondence Address: HOGAN & HARTSON LLP, ONE TABOR CENTER, SUITE 1500, 1200 SEVENTEENTH ST, DENVER, CO, 80202, US

(21) Appl. No.: 10/142,045

(22) Filed: May 9, 2002

(51) Int. Cl. G06F 12/00

(52) U.S. Cl. 711/104

(57) ABSTRACT

A multi-adaptive processor element architecture incorporating a field programmable gate array (“FPGA”) control element having at least one embedded processor core and a pair of user FPGAs forming a user array is disclosed in conjunction with high volume dynamic random access memory (“DRAM”) and dual-ported static random access memory (“SRAM”) banks. In operation, the DRAM is “read” using its fast sequential burst modes and the lower capacity SRAM banks are then randomly loaded allowing the user FPGAs to experience very high random access data rates from what appears to be a very large virtual SRAM. The reverse also happens when the user FPGAs are “writing” data to the SRAM banks. These overall control functions may be managed by an on-chip DMA engine that is implemented in the control FPGA.

### CROSS REFERENCE TO RELATED PATENTS

The present invention is related to the subject matter of U.S. Pat. Nos. 6,076,152; 6,247,110 and 6,339,819 assigned to SRC Computers, Inc., Colorado Springs, Colo., assignee of the present invention, the disclosures of which are herein specifically incorporated in their entirety by this reference.

### BACKGROUND OF THE INVENTION

The present invention relates, in general, to the field of adaptive or reconfigurable processors. More particularly, the present invention relates to a multi-adaptive processor (“MAP™”, a trademark of SRC Computers, Inc., assignee of the present invention) element architecture incorporating a field programmable gate array (“FPGA”) control element having at least one embedded processor core.

Adaptive processors, sometimes referred to as reconfigurable processors, are processor elements that have the ability to alter their hardware functionality based on the program they are running. When compared to a standard microprocessor that can only sequentially execute pre-implemented logic, the adaptive processor has the ability to perform thousands of times more efficiently on a given program. When the next program is run, the logic is reconfigured via software, to again perform very efficiently. The integrated circuits used in these adaptive processors have historically fallen into two categories, namely the custom coprocessor application specific integrated circuits (“ASICs”), and the FPGAs.

Many architectures have been proposed for custom integrated circuit chips containing both microprocessor features and programmable logic portions. These chips however, represent a poor implementation for high performance general purpose adaptive computing since they still have the very high non-recurring costs associated with a high performance custom ASIC, which in turn requires very large markets to make them economically viable. In addition, since both the normal microprocessor and the programmable logic are formed on the same die, the amount of reconfigurable logic will necessarily be much less than if they were each in provided as a discrete part. Since the performance of an adaptive processor is directly proportional to the number of gates it can utilize, this solution is severely limited and is best suited for specialized, limited use, adaptive processors.

An alternative to this approach is to use FPGAs to accomplish the adaptive computing function. However, these chips have historically been relatively small in terms of gate count. In addition, some portion of the gates of the FPGA also had to be used for control functions needed to communicate with the rest of the system. This led to their use primarily in board level products that were designed to target specific families of applications with limited input/output (“I/O”) functionality. However, with recent advances in FPGA geometry, features and packaging, it has now become possible to implement new board level architectures that can be used to accomplish large scale high performance general purpose adaptive computing. One such computer is based on the unique SRC Computers, Inc. MAP™ multi-adaptive processor element architecture disclosed herein.

### SUMMARY OF THE INVENTION

Disclosed herein is a multi-adaptive processor element architecture incorporating an FPGA control element which may have at least one embedded processor core. The overall architecture has as its primary components three FPGAs, DRAM and dual-ported SRAM banks, with the heart of the design being the user FPGAs which are loaded with the logic required to perform the desired processing. Discrete FPGAs are used to allow the maximum amount of reconfigurable circuitry and, in a particular embodiment disclosed herein, the performance of the multi-adaptive processor element may be further enhanced by preferably using two such FPGAs to form a user array.

By using two chips, they can be advantageously placed on opposite sides of the printed circuit board opposing each other with the contacts of their ball grid array (“BGA”) packages sharing a common via through the board. Since the I/O pins of these devices are programmable, the two-user FPGAs of the user array can be set up as mirror-image functional pin configurations. This eliminates most of the chip-to-chip routing that would otherwise be required for their interconnection to the degree necessary to allow them to function as effectively one larger device. Further, in this manner the circuit board layer count and cost is also minimized.

This mounting technique also permits the effective use of the largest pin count packages available which will maximize the I/O capability of the user array. Interconnecting the user FPGAs in this fashion makes the electrical loading of these two chips appear as a single electrical termination on the transmission lines that are formed by the traces that connect to the chips. At high data rates, such as that required by a high performance processor, this greatly simplifies termination of these lines leading to improved signal quality and maximum data rates. In current technology, as many as 1500 pins per package can be used and this mounting technique permits the simultaneous implementation of high bandwidth chip-to-chip connectivity, high bandwidth connectivity from one user array directly into a second user array on a different multi-adaptive processor element and high bandwidth connections to multiple banks of discrete dual-ported SRAM.

The dual-ported SRAM banks are used to provide very fast bulk memory to support the user array. To maximize its volume, discrete SRAM chips may be arranged in multiple, independently connected banks. This provides much more capacity than could be achieved if the SRAM were only integrated directly into the FPGAs. Again, the high input/output (“I/O”) counts achieved by the particular packaging employed and disclosed herein currently allows commodity FPGAs to be interconnected to six, 64 bit wide SRAM banks achieving a total memory bandwidth of 4.8 Gbytes/sec with currently available devices and technology.

In operation, the high volume DRAM is “read” using its fast sequential burst modes and the lower capacity SRAM banks are then randomly loaded allowing the user FPGAs to experience very high random access data rates from what appears to be a very large virtual SRAM. The reverse also happens when the user FPGAs are “writing” data to the SRAM banks. These overall control functions may be managed by an on-chip DMA engine that is implemented in the control FPGA.

Specifically disclosed herein is an adaptive processor element for a computer system comprising a first control FPGA; a system interface bus coupled to the control FPGA for coupling the processor element to the computer system; dynamic random access memory (DRAM) coupled to the control FPGA; dual-ported static random access memory (SRAM) having a first port thereof coupled to the control FPGA; and a user array comprising at least one second user FPGA coupled to a second port of the dual-ported SRAM. Various computer system implementations of the adaptive processor element of the present invention disclosed herein are also provided. In each of the possible system level implementations, it should be noted that, while a microprocessor may be used in conjunction with the adaptive processor element(s), it is also possible to construct computing systems using only adaptive processor elements and no separate microprocessors.

Further disclosed herein is an adaptive processor using a discrete control FPGA having embedded processors, a system interface, a peripheral interface, a connection to discrete DRAM and a connection to one port of discrete dual ported SRAM, as well as discrete FPGAs forming a user array, with connections between the FPGAs forming the user array and to a second port of the dual ported discrete SRAM as well as chain port connections to other adaptive processors. The adaptive processor may comprise multiple discrete FPGAs coaxially located on opposite sides of a circuit board to provide the largest possible user array and highest bandwidth, while minimizing chip to chip interconnect complexity and board layer count. Dual-ported SRAM may be used and connected to the control chip and user array in conjunction with DRAM connected to the control chip, to form high speed circular transfer buffers.

An adaptive processor as previously described may further comprise an embedded processor in the control FPGA to create a high speed serial I/O channel to allow the adaptive processor to directly connect to peripheral devices such as disk drives for the purpose of reducing the bandwidth needed on the system interface. It may further comprise logic implemented in the control FPGA to create a high speed serial I/O channel to allow the adaptive processor to directly connect to peripheral devices such as disk drives for the purpose of reducing the bandwidth needed on the system interface. A system interface allows interconnection of multiple adaptive processors without the need for a host microprocessor for each adaptive processor and an embedded microprocessor in the control chip can be used to decode commands arriving via the system interface.

Further, an adaptive processor as previously described comprises SRAM used as common memory and shared by all FPGAs in the user array and can use separate peripheral I/O and system interconnect ports for the purpose of improving system scalability and I/O bandwidth. DRAM may further be used to provide for large on board storage that is also accessible by all other processors in the system.

### BRIEF DESCRIPTION OF THE DRAWINGS

The aforementioned and other features and objects of the present invention and the manner of attaining them will become more apparent and the invention itself will be best understood by reference to the following description of a preferred embodiment taken in conjunction with the accompanying drawings, wherein:

FIG. 1A is a functional block diagram of a particular, representative embodiment of a multi-adaptive processor element incorporating a field programmable gate array (“FPGAs”) control element having embedded processor cores in conjunction with a pair of user FPGAs and six banks of dual-ported static random access memory (“SRAM”);

FIG. 1B is a simplified flowchart illustrative of the general sequence of “read” and “write” operations as between the dynamic random access memory (“DRAM”) and SRAM portions of the representative embodiment of the preceding figure;

FIG. 2 is a system level block diagram of an exemplary implementation of a computer system utilizing one or more of the multi-adaptive processor elements of FIG. 1A in conjunction with one or more microprocessors and memory subsystem banks as functionally coupled by means of a memory interconnect fabric;

FIG. 3 is a further system level block diagram of another exemplary implementation of a computer system utilizing one or more of the multi-adaptive processor elements of FIG. 1A in conjunction with one or more microprocessors functionally coupled to a shared memory resource by means of a switch network;

FIG. 4 is an additional system level block diagram of yet another exemplary implementation of a computer system utilizing one or more of the multi-adaptive processor elements of FIG. 1A in conjunction with one or more microprocessors and having shared peripheral storage though a storage area network (“SAN”); and

FIG. 5 is a partial cross-sectional view of a particular printed circuit board implementation of a technique for the mounting and interconnection of a pair of user FPGAs of possible use in the representative multi-adaptive processor element of FIG. 1A.

### DESCRIPTION OF A REPRESENTATIVE EMBODIMENT

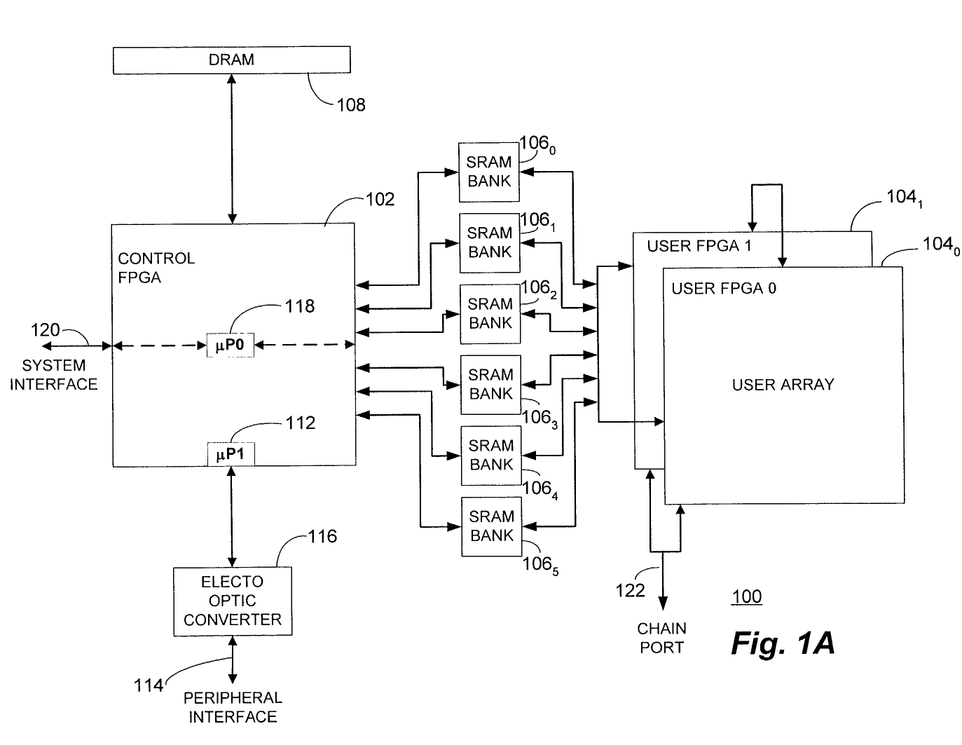

With reference now to FIG. 1A, a functional block diagram of a particular, representative embodiment of a multi-adaptive processor element 100 is shown. The multi-adaptive processor element 100 comprises, in pertinent part, a discrete control FPGA 102 operating in conjunction with a pair of separate user FPGAs 104₀ and 104₁. The control FPGA 102 and user FPGAs 104₀ and 104₁ are coupled through a number of SRAM banks 106, here illustrated in this particular implementation, as dual-ported SRAM banks 106₀ through 106₅. An additional memory block comprising DRAM 108 is also associated with the control FPGA 102.

The control FPGA 102 includes a number of embedded microprocessor cores including μP1 112 which is coupled to a peripheral interface bus 114 by means of an electro optic converter 116 to provide the capability for additional physical length for the bus 114 to drive any connected peripheral devices (not shown). A second microprocessor core μP0 118 is utilized to manage the multi-adaptive processor element 100 system interface bus 120, which although illustrated for sake of simplicity as a single bi-directional bus, may actually comprise a pair of parallel unidirectional busses. As illustrated, a chain port 122 may also be provided to enable additional multi-adaptive processor elements 100 to communicate directly with the multi-adaptive processor element 100 shown.

The overall multi-adaptive processor element 100 architecture, as shown and previously described, has as its primary components three FPGAs 102 and 104₀, 104₁, the DRAM 108 and dual-ported SRAM banks 106. The heart of the design is the user FPGAs 104₀, 104₁ which are loaded with the logic required to perform the desired processing. Discrete FPGAs 104₀, 104₁ are used to allow the maximum amount of reconfigurable circuitry. The performance of this multi-adaptive processor element 100 may be further enhanced by using a maximum of two such FPGAs 104 to form a user array. By using two chips, they can be placed on opposite sides of the circuit board from each other as will be more fully described hereinafter.

The dual-ported SRAM banks 106 are used to provide very fast bulk memory to support the user array 104. To maximize its volume, discrete SRAM chips may be arranged in multiple, independently connected banks 106₀ through 106₅ as shown. This provides much more capacity than could be achieved if the SRAM were only integrated directly into the FPGAs 102 and/or 104. Again, the high input/output (“I/O”) counts achieved by the particular packaging employed and disclosed herein currently allows commodity FPGAs to be interconnected to six, 64 bit wide SRAM banks 106₀ through 106₅ achieving a total memory bandwidth of 4.8 Gbytes/sec.

Typically the cost of high speed SRAM devices is relatively high and their density is relatively low. In order to compensate for this fact, dual-ported SRAM may be used with each SRAM chip having two separate ports for address and data. One port from each chip is connected to the two user array FPGAs 104₀ and 104₁ while the other is connected to a third FPGA that functions as a control FPGA 102. This control FPGA 102 also connects to a much larger high speed DRAM 108 memory dual in-line memory module (“DIMM”). This DRAM 108 DIMM can easily have 100 times the density of the SRAM banks 106 with similar bandwidth when used in certain burst modes. This allows the multi-adaptive processor element 100 to use the SRAM 106 as a circular buffer that is fed by the control FPGA 102 with data from the DRAM 108 as will be more fully described hereinafter.

The control FPGA 102 also performs several other functions. In a preferred embodiment, control FPGA 102 may be selected from the Virtex Pro family available from Xilinx, Inc. San Jose, Calif., which have embedded Power PC microprocessor cores. One of these cores (μP0 118) is used to decode control commands that are received via the system interface bus 120. This interface is a multi-gigabyte per second interface that allows multiple multi-adaptive processor elements 100 to be interconnected together. It also allows for standard microprocessor boards to be interconnected to multi-adaptive processor elements 100 via the use of SRC SNAP™ cards. (“SNAP” is a trademark of SRC Computers, Inc., assignee of the present invention; a representative implementation of such SNAP cards is disclosed in U.S. patent application Ser. No. 09/932,330 filed Aug. 17, 2001 for: “Switch/Network Adapter Port for Clustered Computers Employing a Chain of Multi-Adaptive Processors in a Dual In-Line Memory Module Format” assigned to SRC Computers, Inc., the disclosure of which is herein specifically incorporated in its entirety by this reference.) Packets received over this interface perform a variety of functions including local and peripheral direct memory access (“DMA”) commands and user array 104 configuration instructions. These commands may be processed by one of the embedded microprocessor cores within the control FPGA 102 and/or by logic otherwise implemented in the FPGA 102.

To increase the effective bandwidth of the system interface bus 120, several high speed serial peripheral I/O ports may also be implemented. Each of these can be controlled by either another microprocessor core (e.g. μP1 112) or by discrete logic implemented in the control FPGA 102. These will allow the multi-adaptive processor element 100 to connect directly to hard disks, a storage area network of disks or other computer mass storage peripherals. In this fashion, only a small amount of the system interface bus 120 bandwidth is used to move data resulting in a very efficient system interconnect that will support scaling to high numbers of multi-adaptive processor elements 100. The DRAM 108 on board any multi-adaptive processor element 100 can also be accessed by another multi-adaptive processor element 100 via the system interface bus 120 to allow for sharing of data such as in a database search that is partitioned across several multi-adaptive processor elements 100.

With reference additionally now to FIG. 1B, a simplified flowchart is shown illustrative of the general sequence of “read” and “write” operations as between the DRAM 108 and SRAM bank 106 portions of the representative embodiment of the preceding figure. At step 150, reads are performed by the DMA logic in the control FPGA 102 using sequential addresses to achieve the highest bandwidth possible from the DRAM 108. At step 152 the DMA logic then performs “writes” to random address locations in any number of the SRAM banks 106.

Thereafter, at step 154, the use of dual-ported SRAM allows the control FPGA 102 to continuously “write” into the SRAM banks 106 while the user FPGAs 104 continuously “reads” from them as well. At step 156, the logic in the user FPGAs 104 simultaneously performs high speed “reads” from the random addresses in the multiple SRAM banks 106. As indicated by step 158, the previously described process is reversed during “writes” from the user FPGAs 104 comprising the user array.

Briefly, the high volume DRAM 108 is “read” using its fast sequential burst modes and the lower capacity SRAM banks 106 are then randomly loaded allowing the user FPGAs 104 to experience very high random access data rates from what appears to be a very large virtual SRAM. The reverse also happens when the user FPGAs are “writing” data to the SRAM banks 106. These overall control functions may be managed by an on-chip DMA engine that is implemented in the control FPGA 102.

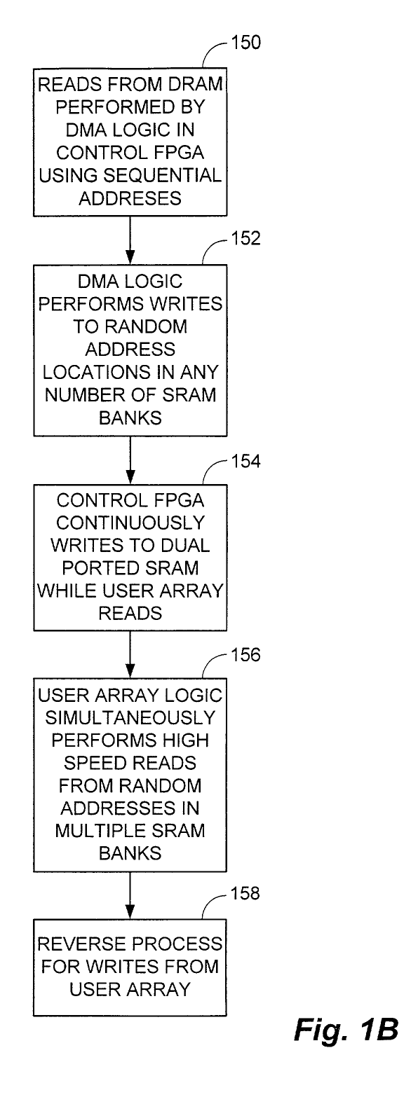

With reference additionally now to FIG. 2, a system level block diagram of an exemplary implementation of a computer system 200 is shown. This particular embodiment of a computer system 200 may utilize one or more of the multi-adaptive processor elements 100₀ through 100_{N} of FIG. 1A in conjunction with one or more microprocessors 202₀ through 202_{M} and memory subsystem banks 206₀ through 206_{M} as functionally coupled by means of a memory interconnect fabric 204.

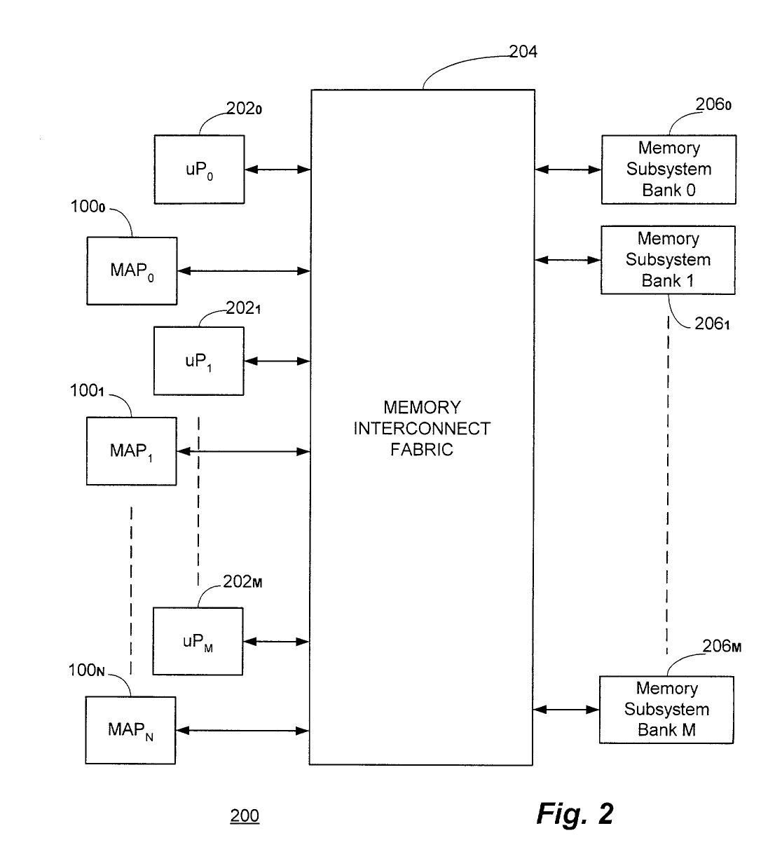

With reference additionally now to FIG. 3, a further system level block diagram of another exemplary implementation of a computer system 300 is shown. This particular embodiment of a computer system 300 may also utilize one or more of the multi-adaptive processor elements 100₀ through 100_{N} of FIG. 1A in conjunction with one or more microprocessors 302₀ through 302_{M} functionally coupled to a switch network 304 by means of a system interface bus 320 and, in turn, to a shared memory resource 306. Through the provision of individual peripheral interface busses 314, each of the multi-adaptive processor elements 100₀ through 100_{N} may directly access attached storage resources 308 as may one or more of the microprocessors 302₀ through 302_{M} through a peripheral bus 312. A number of chain ports 322 may provide direct coupling between individual multi-adaptive processor elements 100₀ through 100_{N}.

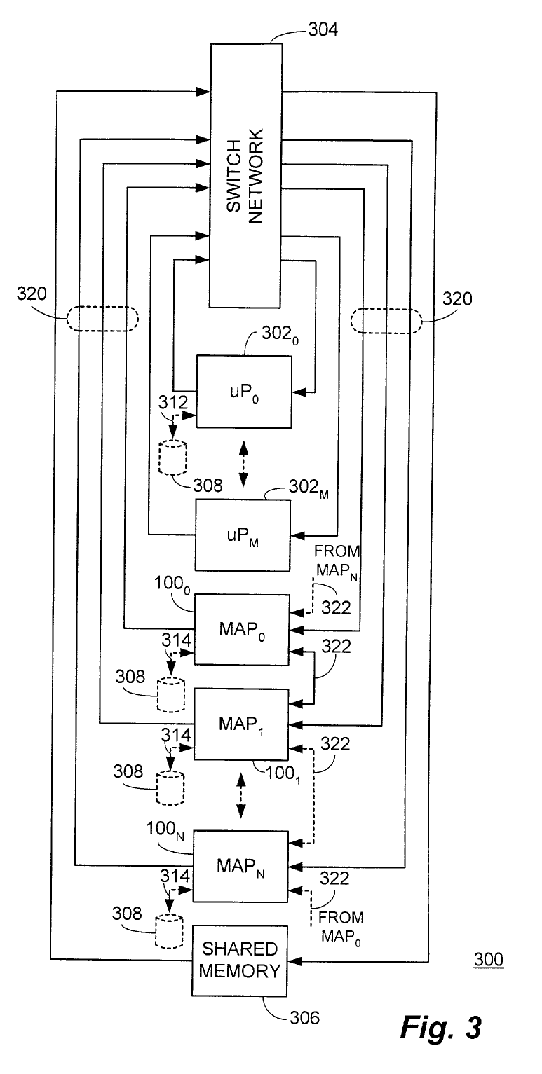

With reference additionally now to FIG. 4, an additional system level block diagram of yet another exemplary implementation of a computer system 400 is shown. This particular implementation of a computer system 400 may additionally utilize one or more of the multi-adaptive processor elements 100₀ through 100_{N} of FIG. 1A in conjunction with one or more microprocessors 402₀ through 402_{M} coupled to the multi-adaptive processing elements 100 through respective system interface buses 420 and SNAP cards 416 as previously described. The multi-adaptive processor elements 100₀ through 100_{N} may be directly coupled to each other by means of chain ports 422 as shown.

In this implementation, the microprocessors 402₀ through 402_{M} are coupled by means of a network 404 and the multi-adaptive processor elements 100₀ through 100_{N} and microprocessors 402₀ through 402_{M} may each have a directly coupled storage element 408 coupled to a peripheral interface 414 or 412 respectively. Alternatively, the multi-adaptive processor elements 100₀ through 100_{N} and microprocessors 402₀ through 402_{M} may each be coupled to a storage area network (“SAN”) to access shared storage 410.

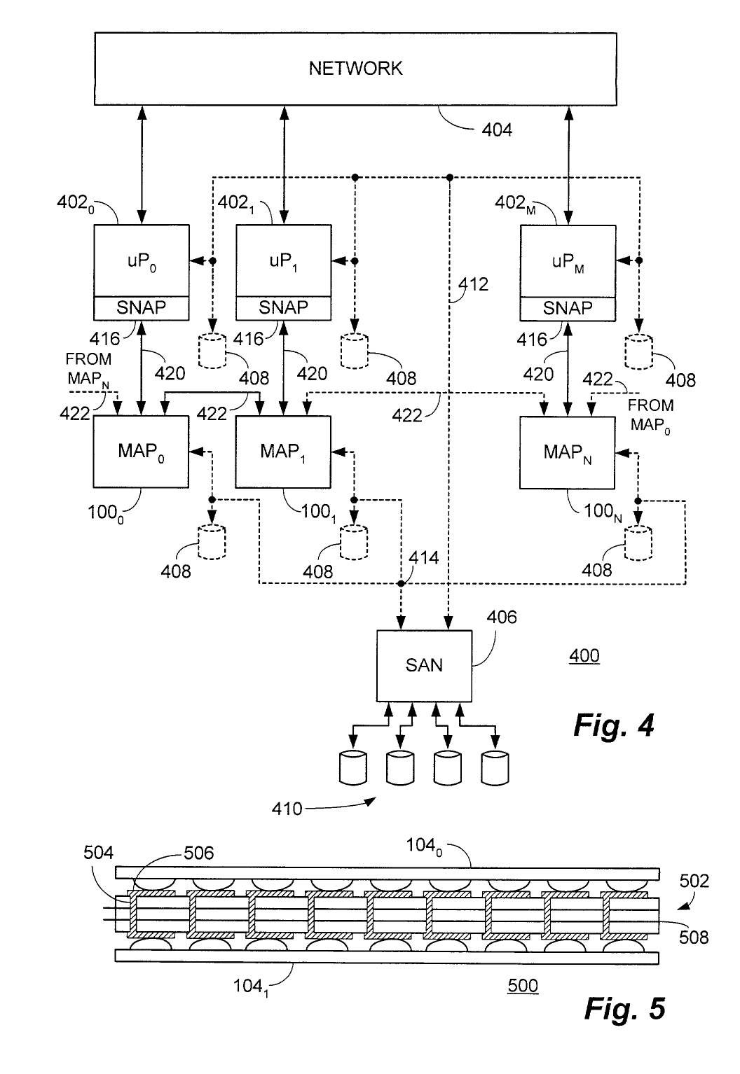

With reference additionally now to FIG. 5, a partial cross-sectional view of a particular printed circuit board 500 is shown. In accordance with the mounting configuration shown, the two user FPGAs 104₀ and 104₁ (FIG. 1A) may be mounted and interconnected as shown, particularly when furnished in a ball grid array (“BGA”) configuration. The contacts of the user FPGAs 104₀ and 104₁ are soldered to opposing sides of a multi-layer printed circuit board 502 which includes a number of through board vias 504 with associated, offset contact pads 506. A number of electrical interconnects 508 provide electrical connections to the vias 504 and contact pads 506 and, in turn, to both of the user FPGAs 104₀ and 104₁.

Discrete FPGAs 104 are used for the user array to allow the maximum amount of reconfigurable circuitry. The performance of this multi-adaptive element 100 (FIG. 1A) is further enhanced by using a preferred two of such FPGAs 104 to form the user array. By using two chips, they can be placed on opposite sides of the printed circuit board 502 opposing each other with the contacts of their BGA packages sharing a common via 504 through the board. Since the I/O pins of these devices are programmable, the two user FPGAs 104₀ and 104₁ can be set up as mirror-image functional pin configurations. This eliminates most of the chip-to-chip routing that would otherwise be required for their interconnection to the degree necessary to allow them to function as effectively one larger device. Further, in this manner circuit board 502 layer count and cost is also minimized. This mounting technique also permits the effective use of the largest pin count packages available which will maximize the I/O capability of the user array. Interconnecting the user FPGAs 104 of the user array in this fashion makes the electrical loading of these two chips appear as a single electrical termination on the transmission lines that are formed by the traces that connect to the chips. At high data rates, such as that required by a high performance processor, this greatly simplifies termination of these lines leading to improved signal quality and maximum data rates. In current technology, as many as 1500 pins per package can be used and this mounting technique permits the simultaneous implementation of high bandwidth chip-to-chip connectivity, high bandwidth connectivity from one user array directly into a second user array on a different multi-adaptive processor element 100 and high bandwidth connections to multiple banks of discrete dual-ported SRAM 106.

With respect to the exemplary implementations of the computer systems 200 (FIG. 2), 300 (FIG. 3) and 400 (FIG. 4), it should be noted that, while the microprocessors 202, 302 and 402 respectively may be furnished as commercially available integrated circuit microprocessors, other implementations for such a processor or processing element may also be used, for example, the multi-adaptive processor element 100 disclosed herein.

While there have been described above the principles of the present invention in conjunction with specific computer system architectures and multi-adaptive processor element configurations, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features which are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

What is claimed is:

1. An adaptive processor element for a computer system comprising:
a first control FPGA;
a system interface bus coupled to said control FPGA for coupling said processor element to said computer system;
dynamic random access memory (DRAM) coupled to said control FPGA;
dual-ported static random access memory (SRAM) having a first port thereof coupled to said control FPGA; and
a user array comprising at least one second user FPGA coupled to a second port of said dual-ported SRAM.

2. The processor element of claim 1 wherein said first control FPGA comprises at least one embedded microprocessor core.

3. The processor element of claim 2 wherein said at least one embedded microprocessor core is coupled to said system interface bus.

4. The processor element of claim 2 wherein said at least one embedded microprocessor core is coupled to a peripheral interface bus.

5. The processor element of claim 4 further comprising:
at least one storage element coupled to said peripheral interface bus.

6. The processor element of claim 4 further comprising:
a storage area network coupled to said peripheral interface bus.

7. The processor element of claim 1 wherein said system interface bus is coupled to said computer system by means of a switch network.

8. The processor element of claim 7 further comprising:
at least one processor coupled to said switch network.

9. The processor element of claim 7 further comprising:
a shared memory resource coupled to said switch network.

10. The processor element of claim 1 wherein said system interface bus is coupled to a processor by means of a switch network adapter port.

11. The processor element of claim 10 wherein said processor is coupled to another processor by means of a switch network.

12. The processor element of claim 1 wherein said dual-ported SRAM comprises a plurality of dual-ported SRAM devices.

13. The processor element of claim 12 wherein said dual-ported SRAM comprises six dual-ported SRAM devices.

14. The processor element of claim 1 wherein said user array comprises second and third user FPGAs.

15. The processor element of claim 14 wherein said second and third user FPGAs are mounted on opposite sides of a circuit board having a plurality of interconnecting vias therethrough.

16. The processor element of claim 1 further comprising:
a chain port coupled to said user array for providing direct access to at least one other processor element of said computer system.

17. A computer system comprising:
a switch network;
at least one adaptive processor element comprising a first control FPGA, a system interface bus coupled to said control FPGA for coupling said processor element to said switch network, dynamic random access memory (DRAM) coupled to said control FPGA, dual-ported static random access memory (SRAM) having a first port thereof coupled to said control FPGA and a user array comprising at least one second user FPGA coupled to a second port of said dual-ported SRAM;
at least one processor coupled to said switch network; and
a shared memory resource coupled to said switch network.

18. The computer system of claim 17 wherein said first control FPGA comprises at least one embedded microprocessor core.

19. The computer system of claim 18 wherein said at least one embedded microprocessor core is coupled to said system interface bus.

20. The computer system of claim 18 wherein said at least one embedded microprocessor core is coupled to a peripheral interface bus.

21. The computer system of claim 20 further comprising:
at least one storage element coupled to said peripheral interface bus.

22. The computer system of claim 20 further comprising:
a storage area network coupled to said peripheral interface bus.

23. The computer system of claim 17 wherein said at least one processor comprises another adaptive processor element.

24. The computer system of claim 17 wherein said at least one processor comprises a plurality of processors.

25. The computer system of claim 24 wherein said at least one processor is coupled to another one of said plurality of processors by means of said switch network.

26. The computer system of claim 17 wherein said dual-ported SRAM comprises a plurality of dual-ported SRAM devices.

27. The computer system of claim 26 wherein said dual-ported SRAM comprises six dual-ported SRAM devices.

28. The computer system of claim 17 wherein said user array comprises second and third user FPGAs.

29. The computer system of claim 28 wherein said second and third user FPGAs are mounted on opposite sides of a circuit board having a plurality of interconnecting vias therethrough.

30. The computer system of claim 17 further comprising:
a chain port coupled to said user array for providing direct access to at least one other processor element of said computer system.

31. A computer system comprising:
a network;
at least one processor coupled to said network;
a switch network adapter port in operative association with said at least one processor;
at least one adaptive processor element comprising a first control FPGA, a system interface bus coupled to said control FPGA for coupling said processor element to said switch network adapter port, a peripheral interface bus coupled to said control FPGA, dynamic random access memory (DRAM) coupled to said control FPGA, dual-ported static random access memory (SRAM) having a first port thereof coupled to said control FPGA and a user array comprising at least one second user FPGA coupled to a second port of said dual-ported SRAM; and
at least one storage element coupled to said peripheral interface bus.

32. The computer system of claim 31 wherein said first control FPGA comprises at least one embedded microprocessor core.

33. The computer system of claim 32 wherein said at least one embedded microprocessor core is coupled to said system interface bus.

34. The computer system of claim 32 wherein said at least one embedded microprocessor core is coupled to said peripheral interface bus.

35. The computer system of claim 31 wherein said at least one storage element comprises:
a storage area network coupled to said peripheral interface bus.

36. The computer system of claim 35 wherein said at least one processor is also coupled to said storage area network.

37. The computer system of claim 31 wherein said at least one processor comprises another adaptive processor element.

38. The computer system of claim 31 wherein said at least one processor comprises a plurality of processors and a switch network adapter port in operative association with each of said plurality of processors.

39. The computer system of claim 38 wherein each of said plurality of processors is coupled to another one of said plurality of processors by means of said network.

40. The computer system of claim 31 wherein said dual-ported SRAM comprises a plurality of dual-ported SRAM devices.

41. The computer system of claim 40 wherein said dual-ported SRAM comprises six dual-ported SRAM devices.

42. The computer system of claim 31 wherein said user array comprises second and third user FPGAS.

43. The computer system of claim 42 wherein said second and third user FPGAs are mounted on opposite sides of a circuit board having a plurality of interconnecting vias therethrough.

44. The computer system of claim 31 further comprising:
a chain port coupled to said user array for providing direct access to at least one other processor element of said computer system.

45. A circuit board having opposite first and second sides thereof, said circuit board comprising:
first and second pluralities of bonding pads affixed in a generally mirror image relationship to one another on said opposite first and second sides of said circuit board respectively;
first and second integrated circuit devices having programmable input/output pins bonded to a subset of said first and second pluralities of bonding pads respectively; and
a plurality of vias formed intermediate said opposite first and second sides of said circuit board for electrically interconnecting opposing ones of said subset of said first and second pluralities of bonding pads.

46. The circuit board of claim 45 wherein said first and second integrated circuit devices comprise a user array for an adaptive processor element.

47. The circuit board of claim 45 wherein said first and second integrated circuit devices comprise first and second FPGAs.
